(19) United States
(12) Patent Application Publication
(10) Pub. No.: US 2023/0133475 A1
(43) Pub. Date: May 4, 2023

(54) Energy Storage Module, Motor Vehicle Having Same, and Method for Producing an Energy Storage Module

(71) Applicant: Bayerische Motoren Werke Aktiengesellschaft, Muenchen (DE)

(72) Inventors: Andreas KLAFFKI, Unterschleissheim (DE); Markus POETZINGER, Muenchen (DE); Matthias WAGNER, Muenchen (DE)

(21) Appl. No.: 17/793,853

(22) PCT Filed: May 3, 2021
(86) PCT No.: PCT/EP2021/061545

§ 371 Date: Jul. 19, 2022

(30) Foreign Application Priority Data
Jun. 3, 2020 (DE) 10 2020 114 729.5

(51) Int. Cl. H01M 10/613; H01M 10/643; H01M 10/6557; H01M 50/213; H01M 50/249; H01M 50/291

(52) U.S. Cl. CPC H01M 10/613; H01M 10/643; H01M 10/6557; H01M 50/213; H01M 50/249; H01M 50/291; H01M 2220/20

(57) ABSTRACT

An energy storage module having a plurality of electrochemical round cells, which are electrically interconnected in series and/or in parallel, wherein the round cells are arranged adjacent to one another in layers, and at least two layers on top of one another are provided, and two opposite support walls, which retain the two longitudinal ends of the round cells, wherein the support walls have projections, on which the longitudinal ends of the round cells rest, and wherein the projections vary in length along the longitudinal direction of the round cells from layer to layer.

### FIELD

The invention relates to an energy storage module having electrochemical round cells arranged between opposite support walls which retain the two longitudinal ends of the round cells.

### BACKGROUND AND SUMMARY

Electrified motor vehicles are known which obtain their electrical energy for propulsion from electrochemical-based energy storage units. These usually have a plurality of energy storage modules that are electrically interconnected in series and/or in parallel. For example, energy storage modules are known which have small, vertically installed round cells that are inserted into a housing and then encapsulated.

It is an object of the present invention to create an energy storage module which is well suited for series production. This object is achieved by an energy storage module, a motor vehicle, and a method according to the present disclosure. Advantageous developments of the invention are also the subject of the present disclosure.

According to an exemplary embodiment of the invention, an energy storage module is provided, having a plurality of electrochemical round cells, i.e. cylindrical storage cells, which are electrically interconnected in series and/or in parallel, wherein the round cells are arranged adjacent to one another in layers, and at least two layers on top of one another are provided, and two opposite support walls, which retain the two longitudinal ends of the round cells, wherein the support walls have projections, on which the longitudinal ends of the round cells rest, and wherein the projections vary in length in the longitudinal direction of the round cells from layer to layer (or from round cell layer to round cell layer). Thus, an energy storage module that is highly suitable for series production is provided. The projections of different lengths allow the round cells to be inserted in layers so that they rest securely and in a precisely positioned manner on the projections and can be bonded there if necessary. With the energy storage module according to the invention, the position of each of the round cells is adapted to the geometry of the support walls. Compared to an implementation in which a support wall is slid onto an already stacked round cell stack, the energy storage module according to the invention thus causes less or no more displacement when the support walls are slid on, which prevents detachment when adhesive is used.

According to a further exemplary embodiment of the invention, the round cells of a layer are arranged offset by half a diameter transversely to the longitudinal direction of the round cells relative to the round cells of an adjacent layer located above or below. This arrangement is space-saving and leads to additional stability due to the engagement of one round cell layer with the adjacent round cell layer.

According to another exemplary embodiment of the invention, an insertion direction corresponds to a direction in which the round cells can be placed on the projections, wherein in the insertion direction the projections have a greater length in a longitudinal direction of the round cells from layer to layer.

According to a further exemplary embodiment of the invention, a cooler is arranged between adjacent layers in each case. Thus, the cooler is integrated into the energy storage module in a secure, space-saving and stable manner.

According to another exemplary embodiment of the invention, the cooler has a corrugated shape. This allows the cooler to be easily positioned on the round cells during production and to be easily bonded on.

According to a further exemplary embodiment of the invention, the cooler comprises a plurality of cooler strands extending parallel to one another and fluidically connected to each other at their longitudinal ends. In this way, uniform cooling can be achieved over all round cells of a layer.

According to a further exemplary embodiment of the invention, at least some projections have a bearing surface adapted to a contour of the round cells such that the bearing surface bears against a circumferential surface of the round cells over at least 90°. Thus, the position of the round cells is defined during the production process and the round cells are securely retained in their predefined positions after insertion and during displacement of the support walls.

According to a further exemplary embodiment of the invention, the projections associated with a layer are formed contiguously. As a result, the projections stabilize each other so that the individual projections are more stable.

According to a further exemplary embodiment of the invention, a guide wall is formed between adjacent projections (within one layer) in each case. This makes positioning during production, in particular during insertion of the round cells, and during displacement of the support walls even easier and more secure.

In addition, the invention relates to a motor vehicle having such an energy storage module.

In addition, the invention provides a method for producing an energy storage module comprising the steps: providing a plurality of round electrochemical cells; providing two support walls having projections of different lengths and orienting the support walls such that the projections face the other support wall; inserting a plurality of round cells in an insertion direction and depositing the round cells on projections having the greatest length, thereby forming a layer of adjacent round cells; moving the support walls towards each other by a predetermined amount; inserting a plurality of further round cells in the insertion direction and depositing the round cells on projections having a length which is smaller compared to the previous insertion step, thereby forming a further layer of adjacent round cells arranged in the insertion direction adjacent to (in particular above or below) the layer of round cells from the previous insertion step. The projections of different lengths allow the round cells to be inserted in layers, so that they can be placed securely and in an accurately positioned manner on the projections and, if necessary, bonded there. As a result of the method according to the invention, the position of each of the round cells is adapted to the geometry of the support walls. Compared to an implementation in which a support wall is slid onto a stack of round cells, the method according to the invention thus results in less or no more displacement when the support walls are slid on, which prevents detachment when adhesive is used.

According to another exemplary embodiment of the method, prior to the step of inserting a plurality of further round cells, a cooler is placed on the previously formed layer.

According to another exemplary embodiment of the method, the cooler is corrugated before insertion.

According to another exemplary embodiment of the method, the cooler is substantially planar prior to insertion and is formed into a corrugated shape by clamping between two layers of round cells.

According to another exemplary embodiment of the method, the cooler is bonded to the round cells.

According to another exemplary embodiment of the method, the round cells are bonded to the projections.

According to another exemplary embodiment of the method, the steps of moving the support walls towards each other and inserting a plurality of further round cells are repeated in order to form further layers of round cells.

A preferred exemplary embodiment of the present invention is described below with reference to the accompanying drawings.

### BRIEF DESCRIPTION OF THE DRAWINGS

FIG. 1 shows an energy storage module according to an exemplary embodiment of the invention;

FIG. 2a shows a three-dimensional view of a part of the energy storage module of FIG. 1 in a first production step;

FIG. 2b shows a plan view of a part of the energy storage module of FIG. 1 in a first production step;

FIG. 3 shows a three-dimensional view of a part of the energy storage module from FIG. 1 in a second production step;

FIG. 4 shows a three-dimensional view of a part of the energy storage module from FIG. 1 in a third production step;

FIG. 5 shows a three-dimensional view of a part of the energy storage module from FIG. 1 in a fourth production step;

FIG. 6 shows a three-dimensional view of a part of the energy storage module of FIG. 1 in a fifth production step;

FIG. 7 shows a three-dimensional view of a part of the energy storage module of FIG. 1 in a sixth production step;

FIG. 8 shows a three-dimensional view of a part of the energy storage module of FIG. 1 in a seventh production step;

FIG. 9 shows a three-dimensional view of a part of the energy storage module of FIG. 1 in an eighth production step, and

FIG. 10 shows a three-dimensional view of a part of a support wall according to a further exemplary embodiment.

### DETAILED DESCRIPTION

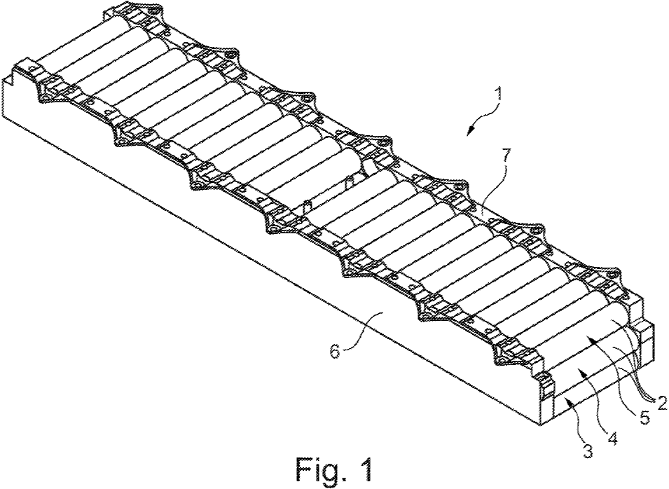

FIG. 1 shows an energy storage module 1 according to an exemplary embodiment of the invention. The energy storage module 1 can be installed in a motor vehicle (not shown), in particular a passenger car. The motor vehicle is an electrified motor vehicle, such as a battery-powered, purely electric vehicle, or a hybrid vehicle.

The energy storage module 1 has a plurality of round cells 2 (i.e., cylindrical storage cells) that store electrical energy on an electrochemical basis and make it available to various vehicle consumers, at least to an electric motor for propelling the motor vehicle. For the sake of clarity, only three round cells are provided with a reference sign. The round cells 2 are rechargeable. In particular, the round cells 2 are the same in respect of their dimensions, in particular the same length. Furthermore, the round cells of the energy storage module 1 are electrically interconnected in series and/or in parallel. For example, the round cells within the energy storage module 1 are divided into groups within which the round cells 2 are electrically interconnected in series, wherein the groups are in turn electrically connected in parallel. A total voltage of all connected round cells 2 can be tapped via an anode and cathode of the energy storage module 1.

The motor vehicle has a plurality of such energy storage modules 1 which are electrically interconnected in series and/or in parallel. In particular, the energy storage modules 1 are electrically connected in parallel. The plurality of round cells 2 of the energy storage module 1 are structurally combined to form a unit, so that each of the energy storage modules 1 is substantially cuboidal. Preferably, the energy storage module 1 is installed in the motor vehicle such that longitudinal axes of the round cells 2 are substantially parallel to the roadway. However, other installation positions are also possible, for example, the energy storage module could be installed in a motor vehicle such that the longitudinal axes of the round cells 2 are oriented parallel to a vertical axis of the motor vehicle.

The round cells 2 are arranged in a first layer 3, a second layer 4 and a third layer 5. However, there may also be more or fewer than three layers, for example two, four, five, etc. Within each layer 3 - 5, the round cells 2 are arranged adjacently. The individual layers 3 - 5 of round cells 2 are arranged one above the other. The round cells 2 of adjacent layers 3 - 5 are arranged offset from the round cells of any other layer by half the diameter of a round cell 2, specifically in a direction transverse to the longitudinal axes of the round cells 2, in particular in a direction in a longitudinal direction of the energy storage module 1.

The longitudinal ends of the individual round cells 2 are all retained by two opposite support walls 6 and 7. The support walls 6 and 7 are arranged parallel to each other.

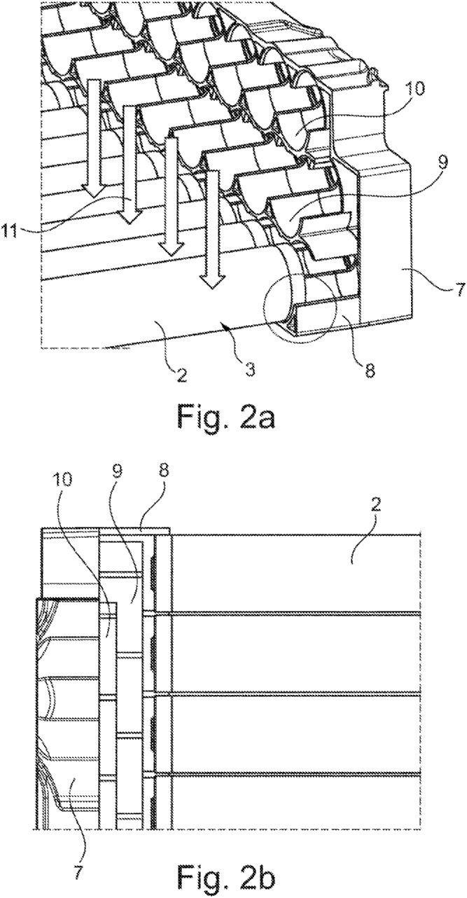

FIG. 2a shows a three-dimensional view of a part of the energy storage module 1 of FIG. 1 in a first production step. As can be seen in FIG. 2a, the support walls 6 and 7 have projections 8, 9, 10, on which the round cells 2 rest. The projections 8 - 10 have a different length in one direction along the longitudinal axes of the round cells 2. More precisely, the projections 8, which are associated with the first layer 3 of round cells 2, have the longest length. The projections 10, which are associated with the third layer 5 of round cells 2, have the shortest length. The length of the projections 9 associated with the second layer 4 have a length in between. In other words, the length of the projections 8 - 10 gradually decreases from a first layer, which is inserted first during the production process, to a last layer.

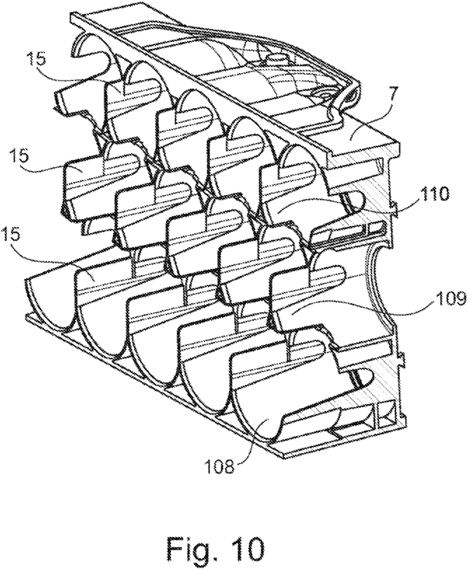

The projections 8 - 10 can be substantially half-shell-shaped. Their bearing surfaces, which are designed for supporting the end regions of the round cells 2, are designed such that the shape of the bearing surfaces is such that the bearing surfaces bear against a portion of the circumferential surfaces of the round cells 2. The projections 8 - 10 can be designed contiguously, so that in each layer each projection continuously adjoins the adjacent projection. However, the projections 8 - 10 can also be formed individually, as shown in FIG. 10.

The production steps described below are not to be understood as exhaustive, and instead, of course, there can be preceding steps, intermediate steps or downstream production steps not described below.

In a first production step, the two support walls 6 and 7 are placed parallel to each other. As shown in FIG. 1b, the round cells 2 of the first layer 3 are placed on the projections 8 (with the longest length) in an insertion direction 11. For this purpose, the support walls 6, 7 must be spaced apart in such a way that both longitudinal ends of the round cells 2 come to rest on the projections 8 and these round cells 2 can be guided past the remaining projections 9, 10 arranged above them.

As can be seen in the plan view of FIG. 2b, the support walls 6, 7 are spaced apart from one another in this first production step in such a way that, when the round cells 2 of the first layer 3 are in the placed state, the longitudinal ends are slightly spaced apart from the projections 9, 10 located above them in the plan view.

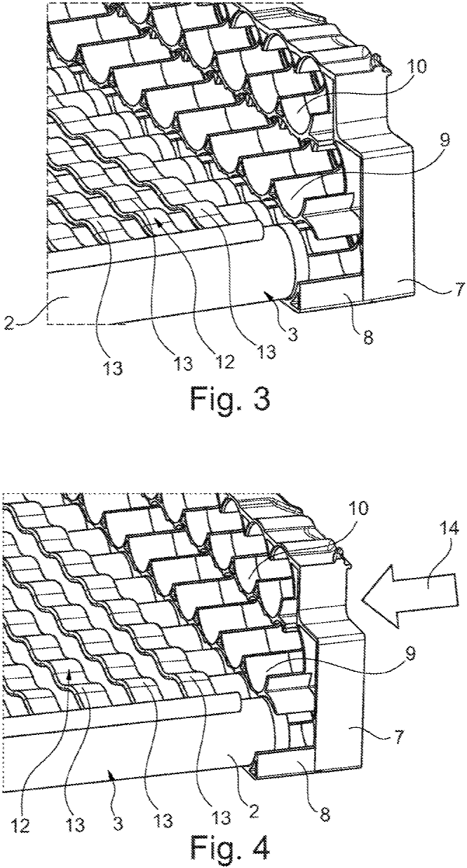

FIG. 3 shows a three-dimensional view of a part of the energy storage module 1 from FIG. 1 in a second production step. A cooler 12 is arranged between each of the layers of round cells 2, the layers being adjacent in the insertion direction. These coolers comprise a plurality of cooler strands 13, for example in the form of flat strips, which are interconnected at their longitudinal ends and through which coolant or refrigerant can flow in their interior. In this case, the cooler strands 13 are already pre-formed in a corrugated shape or are substantially rectilinear and are only brought into this corrugated shape by clamping them between two layers of round cells 2. The cooler 13 is bonded to the layer of round cells 2 below and/or above it using a thermally conductive adhesive, in particular a heat-conductive potting compound. This adhesive is applied to the round cells 2, for example, before the cooler 13 is placed on them.

FIG. 4 shows a three-dimensional view of a part of the energy storage module 1 of FIG. 1 in a third production step. After all round cells 2 of the first layer 3 have all been placed on the corresponding projections 8 and the cooler 13 has been bonded on, the support walls 6, 7 are pushed towards each other, as indicated by the arrow 14. The support walls 6, 7 are pushed towards each other by such a distance (for example 10 mm) that the longitudinal ends of the round cells 2 of the second layer 4 come to rest on the projections 9 during the subsequent placement, but can be guided past the projections 10 above them.

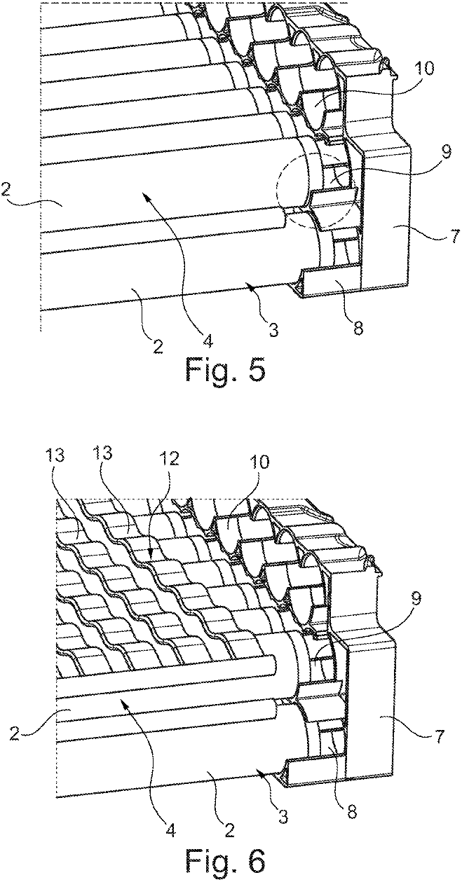

FIG. 5 shows a three-dimensional view of a part of the energy storage module 1 of FIG. 1 in a fourth production step. Here, the round cells 2 of the second layer 4 are placed on the projections 9 of medium length in the insertion direction 11. This is done as already described in conjunction with the round cells 2 of the first layer 3.

FIG. 6 shows a three-dimensional view of a part of the energy storage module 1 of FIG. 1 in a fifth production step.

In this production step, a cooler 12 is applied to the second layer 4 of round cells 2. The description for FIG. 3 applies here accordingly.

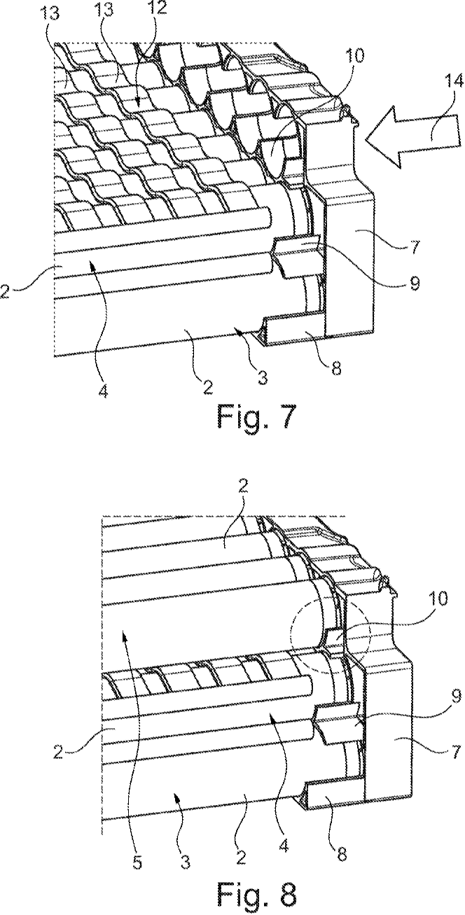

FIG. 7 shows a three-dimensional view of a part of the energy storage module of FIG. 1 in a sixth production step. As explained in conjunction with FIG. 4, the support walls 6, 7 are pushed towards each other, as indicated by the arrow 14. In this process, the support walls 6, 7 are pushed towards each other by such an amount that the longitudinal ends of the round cells 2 of the third layer 5 come to rest on the projections 10 during the subsequent placement, and the longitudinal ends of the round cells 2 of the third layer 5 have only a small clearance with respect to the inner sides of the support walls 6, 7.

FIG. 8 shows a three-dimensional view of a part of the energy storage module 1 from FIG. 1 in a seventh production step. Here, the round cells 2 of the third layer 5 are placed on the projections 10. The support walls 6, 7 can be spaced apart from each other here in such a way that there is only a very small gap between the end faces of the round cells 2 and the corresponding inner faces of the support walls 6, 7.

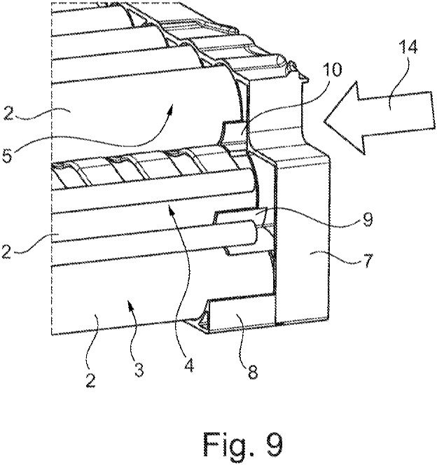

FIG. 9 shows a three-dimensional view of a part of the energy storage module from FIG. 1 in an eighth production step. Here, the support walls 6, 7 are moved towards each other or pressed towards each other, as indicated by the arrow 14.

There are various possibilities for attaching the round cells 2 to the support walls 6, 7 or for forming a stable overall assembly. For example, the round cells 2 can be bonded to the projections 8 - 10 by applying a slow-curing adhesive to the projections 8 - 10 before the individual round cells 2 are placed thereon.

This adhesive must allow the support walls 6, 7 to be moved towards each other in accordance with the arrow 14 and must not cure until after the eighth production step, in such a way that it is no longer possible to move the support walls 6, 7. Another possibility would be to pour a curing or curable compound around the round cells 2 and optionally the support walls 6, 7. Another possibility would be to use an adhesive to bond the round cells 2 to the projections 8 - 10 or the inner sides of the support walls 6, 7 only after the eighth production step. Yet another possibility would be to surround the assembly of support walls 6, 7 and round cells 2 with a frame or a housing. Another possibility would be to connect the longitudinal ends of the support walls 6, 7 by means of two tie rods, so that a closed frame is formed by the two support walls 6, 7 and two tie rods. These tie rods could be bonded, screwed, welded or clicked to the longitudinal ends of the support walls 6, 7.

FIG. 10 shows a three-dimensional view of a part of a support wall 7 according to a further exemplary embodiment. In contrast to the preceding exemplary embodiment, projections 108, 109 and 110 are provided which are provided with guide walls 15 extending from the projections 108, 109 and 110 in a direction opposite to the insertion direction 11. The guide walls 15 extend between the end regions of two adjacent round cells 2 of the same layer when the round cells 2 are placed in position. The guide walls 15 are on the one hand helpful for positioning during insertion of the round cells 2 on the projections 108 - 110 and on the other hand they retain the round cells 2 in their predetermined positions while the support walls 6, 7 are pushed towards each other.

The projections 108, which are associated with the round cells 2 of the first layer 3, are substantially the same as the projections 8, except for the guide walls 15. The projections 109 are associated with the round cells 2 of the second layer 4 and, unlike the projections 9, are not contiguous. The projections 110 are associated with the round cells 2 of the third layer 5 and, unlike the projections 10, are not contiguous. With regard to the change in length from layer to layer, the same applies as described in conjunction with the projections 8 - 10.

While the invention has been illustrated and described in detail in the drawings and the foregoing description, this illustration and description is intended to be exemplary and not limiting and it is not intended to limit the invention to the disclosed exemplary embodiment. The mere fact that certain features are described in various dependent claims is not intended to imply that a combination of such features could not also be advantageously used.

1-17. (canceled)

18. An energy storage module comprising:
a plurality of electrochemical round cells, which are electrically interconnected in series and/or in parallel, wherein the round cells are arranged adjacent to one another in layers, and at least two layers on top of one another are provided; and
two opposite support walls, which retain longitudinal ends of the round cells,
wherein the two opposite support walls comprise projections on which the longitudinal ends of the round cells rest, and
wherein the projections vary in length in a longitudinal direction of the round cells from layer to layer.

19. The energy storage module according to claim 18, wherein the round cells of a first layer are arranged offset by half a diameter of the round cells transversely to the longitudinal direction of the round cells relative to the round cells of an adjacent second layer located above or below the round cells of the first layer.

20. The energy storage module according to claim 18, wherein an insertion direction corresponds to a direction in which the round cells can be placed on the projections, wherein in the insertion direction the projections have a greater length in a longitudinal direction of the round cells from layer to layer.

21. The energy storage module according to claim 18, further comprising a cooler arranged between adjacent layers.

22. The energy storage module according to claim 21, wherein the cooler has a corrugated shape.

23. The energy storage module according to claim 21, wherein the cooler comprises a plurality of cooler strands extending parallel to each other and fluidically connected to each other at their longitudinal ends.

24. The energy storage module according to claim 18, wherein at least some projections comprise a bearing surface adapted to a contour of the round cells such that the bearing surface bears against a circumferential surface of the round cells over at least 90°.

25. The energy storage module according to claim 18, wherein the projections associated with a layer are formed contiguously.

26. The energy storage module according to claim 18, further comprising a guide wall formed between adjacent projections.

27. A motor vehicle comprising the energy storage module according to claim 18.

28. A method for producing an energy storage module, the method comprising:
providing a plurality of round electrochemical cells;
providing two support walls, wherein each support walk comprises projections of different lengths;
orienting each of the two support walls such that the projections face each other;
inserting a first plurality of round cells in an insertion direction and depositing the first plurality of round cells on a first set of projections having a greatest length of the projections to form a first layer of adjacent round cells;
moving at least one of the two support walls towards the other by a predetermined amount; and
inserting a second plurality of round cells in the insertion direction and depositing the second plurality of round cells on a second set of projections having a length which is smaller compared to the first set of projections to form a second layer of adjacent round cells arranged in the insertion direction adjacent to the first layer of adjacent round cells.

29. The method according to claim 28, comprising;
prior to inserting the second plurality of round cells, placing a cooler on the first layer of adjacent round cells.

30. The method according to claim 29, wherein the cooler is corrugated before insertion.

31. The method according to claim 29, wherein the cooler is substantially planar prior to insertion and is formed into a corrugated shape by clamping between the first layer of adjacent round cells and the second layer of adjacent round cells.

32. The method according to claim 29, wherein the cooler is bonded to the round cells.

33. The method according to claim 28, wherein the round cells are bonded to the projections.

34. The method according to claim 28, further comprising:
after inserting the second plurality of round cells, moving at least one of the two support walls towards the other by a predetermined amount; and
inserting a third plurality of round cells in the insertion direction and depositing the third plurality of round cells on a third set of projections having a length which is smaller compared to the second set of projections to form a third layer of adjacent round cells arranged in the insertion direction adjacent to the second layer of adjacent round cells.
